(19) United States
(12) Patent Application Publication
(10) Pub. No.: US 2008/0135357 A1
(43) Pub. Date: Jun. 12, 2008

(54) Electromechanical Braking System

(76) Inventor: Hans Lang, Regensburg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/791,808

(22) PCT Filed: Nov. 11, 2005
(86) PCT No.: PCT/EP05/55903

§ 371 Date: May 29, 2007

(30) Foreign Application Priority Data
Nov. 29, 2004 (DE) 10 2004 057 498.7

(51) Int. Cl. B60L 7/00; B60T 13/74; H02P 4/00; H02J 7/00

(52) U.S. Cl. 188/158; 318/440; 320/166; 320/167

(57) ABSTRACT

The invention relates to an electromechanical braking system, especially for a motor vehicle comprising a 12V/14V on-board supply system. Said braking system comprises a brake actuator unit provided with an electric motor for generating a braking force, and a power supply for the electric motor, said power supply comprising a first electrical energy source, especially an accumulator of an on-board supply system. The power supply of the electric motor also comprises at least one capacitive energy source which is mounted in parallel to the first energy source. The invention further relates to an electromechanical braking system and a motor vehicle, especially a private car, comprising an electromechanical braking system.

### CROSS REFERENCE TO RELATED APPLICATIONS

This application is the US National Stage of International Application No. PCT/EP2005/055903, filed Nov. 11, 2005 and claims the benefit thereof. The International Application claims the benefits of German application No. 10 2004 057 498.7 filed Nov. 29, 2004, both of the applications are incorporated by reference herein in their entirety.

### FIELD OF INVENTION

The invention relates to an electromechanical braking installation, an electromechanical braking system, as well as to a motor vehicle with an electromechanical braking system, with the electromechanical braking installation or the electromechanical braking system being suitable especially for a 12V/14V vehicle electrical system of a motor vehicle.

### BACKGROUND OF THE INVENTION

With an electromechanical braking installation hydraulic devices can be dispensed with completely, with the transmission of commands from the brake pedal to the brake being entirely replaced by electronic signals. The electromechanical brake has brake calipers operated by electric motors to apply the braking force, whereby for safety-relevant systems, devices or facilities, such as in motor vehicles for example, two autonomous electrical circuits are necessary for supplying energy to the brakes, so that if one of the two systems fails, sufficient braking force can still be supplied by the other system.

With electromechanical vehicle brakes the hydraulic cylinder is replaced on each brake disk by a powerful electric motor, with the functions of a hydraulic brake, such as. ABS, ESP or ASR for example, being taken over and the signals of these units no longer having to be converted into hydraulic pressure in order to obtain a corresponding braking effect.

The electrical energy required for braking is provided for the electromechanical braking installation exclusively by the vehicle electrical system (vehicle batteries or accumulators which are charged by a generator during operation of the motor vehicle). Should one brake fail, the others continue to function. Electrical lines are used for signal and energy transmission for the electromechanical brake.

Currently known electromechanical braking installations, which generate the braking force by an electric motor, optionally by means of an additional transmission stage and a spindle, depending on the layout and design of the electromechanical braking installation, require a maximum electrical power per brake actuator unit, i.e. for each wheel of a motor vehicle, of up to more than 1 KW, which however only has to be made available for a very short time (appr. 30 ms). The power required by the electromechanical braking installation is thus very high over the short term. It is thus generally believed that such power can only sensibly be supplied using a 42V vehicle electrical system, since in this way a current load (maximum current flow, current gradient) of the electrical supply leads for the brakes remains within a real range. For operation in a vehicle electrical system with 12V/14V voltage on the one hand the power dissipation increases to an unacceptable level because of heat in the leads as a result of their smaller conductor cross section and high current intensity. On the other hand correspondingly increased lead cross sections would cause the weight of the cable harnesses to be used to increase by several kilograms.

Furthermore equipping a motor vehicle with a (possibly even additional) 42V vehicle electrical system demands far reaching constructional modifications in the motor vehicle, so that new motor vehicles with a 42V vehicle electrical system are disproportionately more expensive compared to motor vehicles with an 12V vehicle electrical system, which represents a significant sales disadvantage for such a motor vehicle with a 42V vehicle electrical system.

### SUMMARY OF INVENTION

The object of the invention is thus to make available an electromechanical braking installation or an electromechanical braking system, especially for motor vehicles,

with the electromechanical braking installation being able to be safely operated with a 12V/14V vehicle electrical system and with all the functions of a conventional hydraulic brake—e.g. those of an antilock braking system (ABS), a traction control, acceleration slip regulation (ASR), an electronic stabilization program (ESP) as well as an automatic brake intervention, e.g. with automatic adaptive cruise control systems, and automatically initiated full braking—able to be handled.

The object of the invention is achieved by means of an electromechanical brake, of which the brake actuator unit is supplied with electrical energy which originates from an additional second electrical energy store provided, which is preferably a capacitive energy store.

The peak power requirement of the electromechanical brake occurs during a fast acceleration of a rotor of the electric motor either at the beginning of braking or, for motor vehicles with ABS, if a wheel slippage between wheel and road is detected by an ABS control device, and the electric motor is switched over very rapidly from applying the brake pad to releasing the brake pad. Using the additional second electrical energy store provided in accordance with the invention, it is now still possible, in electrical networks of which the power supply and/or lead cross sections are actually not suitable for electromechanical braking installations—as is the case with a 12V/14V vehicle electrical system of a motor vehicle—to implement this type of fast and reliable application or release of the brake pads by means of electric motors. By means of the second energy store provided in accordance with the invention it is thus possible to buffer the necessary electrical energy for peak power requirements of an electromechanical brake (i.e. to make it available over a short period through an “intermediate store”) and thus to provide a functional braking installation even with a low-voltage network.

Using the invention it is now especially possible to equip motor vehicles with 12V/14V vehicle electrical system with electromechanical braking installations and to make the safety advantages of such a braking system available to drivers. Using such a brake-by-wire system it is possible to provide each individual wheel with an individual brake force modulation, allowing shorter braking distances with simultaneous high vehicle stability. In addition an electromechanical braking system is readily compatible with known systems (ABS, ASR, ESP etc.) and also opens up further opportunities for additional functions such as what is known as Adaptive Cruise Control (ACC) right through to autonomous traffic guidance systems.

An electronic brake pedal simulator which can ergonomically usefully be arranged in the foot well of a motor vehicle is needed for an electromechanical braking installation and of which the lower actuation forces on braking produces a gain of half a second (TÜV Rheinland) by comparison with hydraulic braking; which, according to the TÜV, reduces the stopping distance at a vehicle speed of 100 km/h by 14 m to 66 m, corresponding to a reduction in the stopping distance by almost 20% (in relation to the stopping distance produced by a conventional brake actuation system).

In a preferred embodiment of the invention the second energy store is located directly on the brake actuator unit or as close as possible to this unit. With such an embodiment, in which the second energy store is accommodated in the immediate vicinity of the location at which its electrical energy will be needed, it is possible to keep the power dissipation for a 12V/14V vehicle electrical system low, since the energy store is charging during the intervals with low current intensities during which no electrical energy needs to be made available for braking. This means that increased cross sections for the brake actuator unit supply leads are not required in order to compensate for the above-mentioned power dissipation. Such a concept is made possible by the fact that much more time is available for charging the second electrical energy store than the store needs for supplying current in the worst case for peak load requirements.

In a preferred embodiment of the invention the second source of energy is a back-up capacitor connected in parallel to the first source of energy of the electromechanical braking installation. Capacitors are ideally suited to accommodating peak requirements since they can be rapidly charged and also rapidly discharged again. In addition to this they have a practically unlimited lifetime, since, by contrast with accumulators, no electrochemical reactions occur within them, but only charges are separated. Such capacitors are very suitable especially for vehicle brakes, in which the capacitor is accommodated directly on the brake actuator unit, because of their light weight, since the brake actuator unit and thus also the capacitor are part of the unsprung mass on the wheel, which should be as small as possible with motor vehicles. In addition small lead cross sections to the capacitor are possible because of the comparatively long charging time (by contrast with its 30 ms (see below) discharging time).

In one inventive embodiment the capacitor has a capacitance of 200 mF to 650 mF, especially 450 mF. The situations in which the brake actuator unit must produce its peak power (start of braking or, in the case of ABS, if wheel slip is detected between wheel and road) last up to around 30 ms (Δt). This means for example that, for an actuator unit with a peak power of appr. 700 W (appr.: 12V*60 A) and a maximum current I in the supply lead of 30 A as well as a voltage drop ΔU of 2V at the capacitor a capacitance of C=I*Δt/ΔU=450 mF is sufficient.

In a preferred embodiment of the invention the back-up capacitor is a so-called Supercap capacitor (Supercap=Supercapacitor). These Supercap capacitors are capacitors with very high capacitance (in the range of several thousand Farad) and are able to be used as energy stores, which means that they can replace rechargeable batteries. Their outstanding features are their small dimensions and a low mass. The high capacitance is made possible by the side surfaces of the capacitor, to which the charges adhere in the charged state, being provided by means of microscopic carbon particles with a very finely structured three-dimensional surface, so that very high surface contents and thus very high capacitances are possible. Furthermore no special requirements are imposed on the exterior shape of such a capacitor, so that almost any forms are possible. All this makes the Supercap capacitors very suitable especially for electromechanical braking actuator units for motor vehicle brakes.

Since Supercap capacitors are temperature-sensitive, these are preferably located in or on a cool area of the brake actuator unit. The temperatures at this location should not exceed 70° C. to 125° C.

In a preferred embodiment of the invention a braking system for a motor vehicle is equipped with electromechanical brakes or brake installations. In addition to the above advantages of a motor vehicle with electromechanical brakes, it is especially of advantage for the brake pedal to have low actuation forces and, in the case of ABS for example, to be non-pulsed and thus not able deceive the driver, who is irritated as a result of a pulsing brake pedal, into taking their foot off the brake. Furthermore the response characteristic of the brake can be set individually.

Further embodiments of the invention emerge from the remaining subclaims.

### BRIEF DESCRIPTION OF THE DRAWINGS

The invention is explained in more detail below on the basis of exemplary embodiments which refer to the enclosed drawing. The drawing shows the following:

FIG. 1 a schematic diagram of an electromechanical braking system for a motor vehicle, and

FIG. 2 a circuit arrangement for an inventive brake actuator unit.

### DETAILED DESCRIPTION OF INVENTION

The following embodiments relate to an electromechanical brake or braking installation or an electromechanical braking system for motor vehicles with a 12V/14V vehicle electrical system. It is pointed out however that the invention is not to be restricted to such an embodiment but is rather to include any electromechanical brakes which can be operated with different supply voltages and for which it can be of advantage to provide a second, preferably capacitive, energy store.

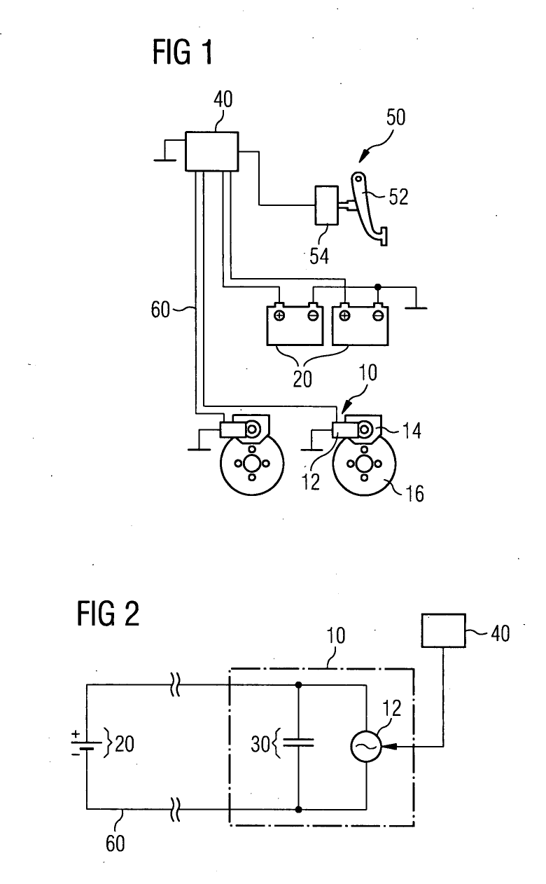

FIG. 1 shows a schematic diagram of an electromechanical braking system for a front and a rear axle of a motor vehicle. The electromechanical braking system features a plurality of electromechanically-operated braking units, which can each brake a brake disk 16 by means of brake pads provided in a brake caliper 14, with the brake disks being actuated by means of an electromechanical brake actuator unit 10. In this case an electric motor 12 and preferably an additional transmission form the brake actuator unit 10, which creates the application forces in the brake caliper 14. Such a brake actuator unit 10 is able within a few milliseconds to provide the necessary brake forces in each case, which can amount to several tons.

A control device 40 processes signals received from a brake pedal simulator 50, where necessary combines them with data of other sensors and control systems, and calculates in individual force needed for each wheel, with which the brake actuator unit 10 is to press the brake pads of the brake caliper 14 onto the brake disk 16.

A brake pedal 52 of the brake pedal simulator 50 is connected to a pedal travel sensor 54, with the pedal travel sensor 54 passing on to the control device 40 a pedal travel and a pedal actuation force determined. The control device 40 passes on the braking deceleration desired by the driver to the brake actuator unit 10. The brake pedal ending in a tactile simulator can no longer vibrate as with conventional hydraulic brakes and thus reduces the danger of an inexperienced driver taking their foot off the brake in a danger situation.

The main energy source of the brake actuator unit 10 is two accumulators 20 which obtain their electrical charge energy from a generator (alternator). In order to avoid a total failure of the braking systems, e.g. if an accumulator 20 fails, two independent vehicle electrical systems are necessary. In the typical braking system shown, an accumulator 20 is assigned to the brakes of a front axle and the other accumulator 20 to the brakes of a rear axle of the vehicle (other combinations are also possible). This ensures that, if the power supply for the brakes of one of the two axles fails, at least the brakes of the other are still completely intact. In addition, if an accumulator 20 fails, the other electromechanical brakes affected by the failure of the accumulator 20 can be switched-in in each case.

Since the space available for installing an electromechanical brake in the motor vehicle is limited and the unsprung weight of the vehicle should be as small as possible, high demands are imposed on the brake actuator unit 10.

Thus the brake actuator unit 10 should be compact and also light to enable it to be accommodated within the wheel rim.

So that neither the power dissipation in the supply leads to the electromechanical brakes increases to an unacceptable level nor do the lead cross sections of the supply leads cause these to increase by several kilograms in weight to counter the above problem; but despite this to enable electromechanical braking to be operated with a 12V/14V vehicle electrical system, it is necessary to buffer the peaks of the power demanded by the brake actuator unit 10 by means of a second source of energy. This is preferably implemented by means of an individual Supercap capacitor for each electromechanical braking installation which is switched as a back-up capacitor for conventional power supply to the brake actuator unit 10.

Such a circuit arrangement can be seen in FIG. 2. A second source of energy 30, preferably a capacitor 30, is connected-in in parallel to the electric motor 12 of the electromechanical brake supplied by an accumulator 20. In this case the capacitor 30 is located as close as possible to the electric motor 12, so that the power dissipation is as low as possible during discharging of the capacitor 30 and in addition the lines between the capacitor 30 and the electric motor 12 do not become too long as a result of a corresponding dimensioning. In this case it should be ensured that the temperature of the capacitor 30 should not be allowed to exceed a specific temperature range between 70° C. and 125° C. This can make it necessary not to provide the capacitor directly on the electric motor 12.

The inventive circuit makes possible the operation of an electromechanical braking installation with a 12V vehicle electrical system instead of the 42V vehicle electrical system previously considered necessary. This means that a separate 42V power supply, which would make for significant extra costs of a motor vehicle, can be dispensed with.

Preferred capacitors for the inventive arrangement are so-called Goldcap, Supercap, or Ultracap capacitors. The outstanding feature of these capacitors is a very high capacitance with simultaneously low weight and small size.

Furthermore it is possible, not only to connect a single capacitor 30 as a back-up capacitor in parallel to the conventional power supply, but to connect a plurality of these capacitors, which are then likewise connected in parallel to the power supply 20 and also in parallel to the capacitor 30.

Conventional Supercap capacitors have a charge voltage U of 2.0 to 2.5V, in which case it is a good idea to connect a plurality of capacitors switched in series overall in parallel to the accumulator 20 in order to integrate them conveniently into a 12V motor vehicle electrical system and not to charge them with a too high voltage U. Depending on the charge voltage U of a capacitor, four to eight, especially five to seven capacitors connected in series, are suitable for this. In this case however it should be ensured that the overall capacitance C_{ges} of series-switched capacitors falls. Thus a network of 5 similar capacitors which are switched in series now only has a capacitance of ⅕ of a single capacitor. Thus if an overall capacitance of 450 mF is to be provided by means of a series circuit of five capacitors, five capacitors each of 2.25 F are necessary for this. Furthermore, for a series circuit of capacitors a longer charge time compared to an individual capacitor must be taken into account.

In addition it is naturally also possible to combine the above two ideas and to connect a number of blocks of series-connected capacitors 30 in parallel to the power supply as a back-up capacitor arrangement. The best number for such a capacitor block is again four to eight, especially five to seven, capacitors 30.

1.-9. (canceled)

10. An electromechanical braking installation, for a motor vehicle with a 12V/14V vehicle electrical system, comprising:
a brake actuator unit having an electric motor for providing a braking force; and
a power supply for the electric motor having:
a first electrical source of energy embodied as an accumulator of a vehicle electrical system energy, and
at least one additional electrical source of energy arranged in the immediate vicinity on or in the brake actuator unit and connected in parallel to the first source of energy.

11. The electromechanical braking installation as claimed in claim 10, wherein the additional source of energy is a capacitor or a series circuit of capacitors that operate as back-up capacitors.

12. The electromechanical braking installation as claimed in claim 11, wherein the capacitor has a capacitance of 200±50 mF.

13. The electromechanical braking installation as claimed in claim 11, wherein the capacitor has a capacitance of 350±50 mF.

14. The electromechanical braking installation as claimed in claim 11, wherein the capacitor has a capacitance of 500±50 mF.

15. The electromechanical braking installation as claimed in claim 11, wherein the capacitor has a capacitance of 650±50 mF.

16. The electromechanical braking installation as claimed in claim 11, wherein series circuit of capacitors consists of five, six or seven capacitors.

17. The electromechanical braking installation as claimed in claim 11, wherein the backup capacitor is a Supercap capacitor.

18. The electromechanical braking installation as claimed in claim 10, wherein the at least one capacitive source of energy is provided in a position in or on the brake actuator unit at which during the operation of the brake the temperature does not rise above 125° C.

19. The electromechanical braking installation as claimed in claim 18, wherein the at least one capacitive source of energy is provided in a position in or on the brake actuator unit at which during the operation of the brake the temperature does not rise above 100° C.

20. The electromechanical braking installation as claimed in claim 19, wherein the at least one capacitive source of energy is provided in a position in or on the brake actuator unit at which during the operation of the brake the temperature does not rise above 85° C.

21. The electromechanical braking installation as claimed in claim 20, wherein the at least one capacitive source of energy is provided in a position in or on the brake actuator unit at which during the operation of the brake the temperature, does not rise above 70° C.

22. The electromechanical braking installation as claimed in claim 10, wherein a plurality of brake actuator units, each unit having an electric motor for providing a braking force are provided.

23. An automobile, comprising:
a plurality of road wheels; and
an electromechanical braking system in communication with the road wheels having:
a brake actuator unit with an electric motor that provides a braking force,
a power supply connected to the electric motor with:
a first electrical source of energy, where the first electrical source of energy is an accumulator of a vehicle electrical energy, and
at least one additional electrical source of energy arranged in the immediate vicinity on or in the brake actuator unit and connected in parallel to the first source of energy.

24. The automobile as claimed in claim 23, wherein the at least one additional source of energy is a capacitor or a series circuit of capacitors that operate as back-up capacitors.

25. The electromechanical braking installation as claimed in claim 24, wherein series circuit of capacitors consists of five, six or seven capacitors.

26. The electromechanical braking installation as claimed in claim 24, wherein the backup capacitor is a Supercap capacitor.
